(19) United States
(12) Patent Application Publication
(10) Pub. No.: US 2010/0116348 A1
(43) Pub. Date: May 13, 2010

(54) System And Method For Evacuating A Vacuum Chamber

(76) Inventors: Raymond G. Buchko, Neenah, WI (US); Dwayne C. Long, New London, WI (US)

Correspondence Address: BOYLE FREDRICKSON S.C., 840 North Plankinton Avenue, MILWAUKEE, WI, 53203, US

(21) Appl. No.: 12/686,810

(22) Filed: Jan. 13, 2010

Related U.S. Application Data
(63) Continuation of application No. 11/747,519, filed on May 11, 2007.
(60) Provisional application No. 60/747,020, filed on May 11, 2006.

(51) Int. Cl. F15D 1/00

(52) U.S. Cl. 137/12; 137/14

(57) ABSTRACT

A valve arrangement for a vacuum pump assembly selectively opens and closes communication between a vacuum pump, evacuation vessel, and a volume to be evacuated. The valve arrangement allows the evacuation vessel and any conduit connecting the vacuum pump and evacuation vessel to the volume to first be evacuated without providing a vacuum to the volume. The valve arrangement also allows the volume to be connected to the evacuation vessel but cut-off from the vacuum pump so that at initial stages of the evacuation process for the volume dead air contained within the volume may be communicated to the evacuation vessel rather than drawn out by the vacuum pump. Once the dead air, or portions thereof, has been removed from the volume, the valve arrangement may cut-off communication with the evacuation vessel, establish communication between the vacuum pump and the volume, and allow the vacuum pump to provide negative air pressure to the volume so that the volume may be evacuated.

### CROSS-REFERENCE TO RELATED APPLICATION

This application claims the benefit of U.S. Ser. No. 60/747,020, filed May 11, 2006, the disclosure of which is incorporated herein by reference.

### BACKGROUND OF THE INVENTION

This invention pertains to a system and method for evacuating a volume or chamber, such as for use in vacuum packaging or in any other application in which a chamber or volume is subjected to negative air pressure.

In a conventional evacuation system, a volume to be evacuated, such as a vacuum chamber, is initially at ambient atmospheric air pressure. When it is desired to evacuate the volume, a vacuum pump is operated so as to subject the volume to negative air pressure. In order to evacuate the volume, the vacuum pump must remove air from the volume as well as from the pipes, hoses, fittings, etc., that extend between the vacuum pump and the volume. This requires movement of a significant amount of dead air before the required negative air pressure is reached within the interior of the volume. In many applications, the volume of dead air that must be moved makes it necessary to utilize a relatively high capacity vacuum pump in order to evacuate the interior of the volume within a desired period of time. For example, in equipment that operates in a cyclic manner, such as vacuum packaging equipment, the time required to evacuate the interior of the vacuum chambers often can be the limiting factor in reducing cycle times. In applications that are not cyclic in nature, such as single chamber vacuum packaging equipment, metalizing chambers, vacuum chambers for semiconductor manufacture, etc., the evacuation time simply translates into operator downtime while waiting for the volume or chamber to be evacuated.

### BRIEF DESCRIPTION OF THE INVENTION

The present inventors have discovered that an evacuation system incorporating an evacuation vessel in fluid communication with the vacuum pump and volume to be evacuated and a valve arrangement that selectively opens and closes communication between the vacuum pump, evacuation vessel, and volume to be evacuated, functions to overcome some of the drawbacks generally associated with conventional evacuation systems, such as those enumerated above. In one embodiment of the present invention, the valve arrangement allows the evacuation vessel and any conduit connecting the vacuum pump and evacuation vessel to the volume to first be evacuated without providing a vacuum to the volume. The valve arrangement also allows the volume to be fluidly connected to the evacuation vessel but cut-off from the vacuum pump so that at initial stages of the evacuation process, dead air contained within the volume may be communicated to the evacuation vessel rather than drawn out by the vacuum pump. Once the dead air, or portions thereof, has been removed from the volume, the valve arrangement may cut-off communication with the evacuation vessel, establish communication between the vacuum pump and the volume, and allow the vacuum pump to provide negative air pressure to the volume so that the volume may be evacuated in preparation for a subsequent evacuation of the volume.

It is therefore an object of the present invention to provide a system and method for evacuating a volume or chamber, which is capable of evacuating the volume or chamber in much less time than is required with conventional evacuation systems. It is a further object of the invention to provide such a system and method that enables use of a smaller vacuum pump than has been heretofore required for vacuum systems. Yet another object of the invention is to provide such a system and method which is relatively simple in implementation, and which can easily be adapted for use in any type of vacuum system either during original manufacture or in a retrofit application.

Various other features, objects and advantages of the present invention will be made apparent from the following detailed description and the drawings.

### BRIEF DESCRIPTION OF THE DRAWINGS

The drawings illustrate one preferred embodiment presently contemplated for carrying out the invention.

In the drawings:

FIG. 1 is an isometric view of a linear motion vacuum packaging system, which is a representative application for the system and method for evacuating a volume or chamber in accordance with the present invention;

FIG. 2 is an isometric view of a control valve system incorporated into the vacuum packaging system of FIG. 1 for carrying out the evacuation system and method of the present invention;

FIG. 3 is a section view of the control valve system taken along line 3-3 of FIG. 2;

FIG. 4 is a schematic view of the evacuation system and method of the present invention, in which a control valve system as in FIG. 3 is operative to provide negative pressure to a conduit connecting a vacuum pump to a vessel and a volume to be evacuated;

FIG. 5 is a view similar to FIG. 4 showing the control valve system operative to cut-off communication between the vacuum pump and the volume to be evacuated but allowing communication between the vessel and the volume to be evacuated;

FIG. 6 is a view similar to FIGS. 4-5 showing the control valve system operative to cut-off communication between the volume to be evacuated and both the vacuum pump and the vessel; and

FIG. 7 is a view similar to FIGS. 4-6 showing the control valve system operative to cut-off communication between the volume to be evacuated and the vessel but allow communication between the vacuum pump and the volume to be evacuated.

### DETAILED DESCRIPTION

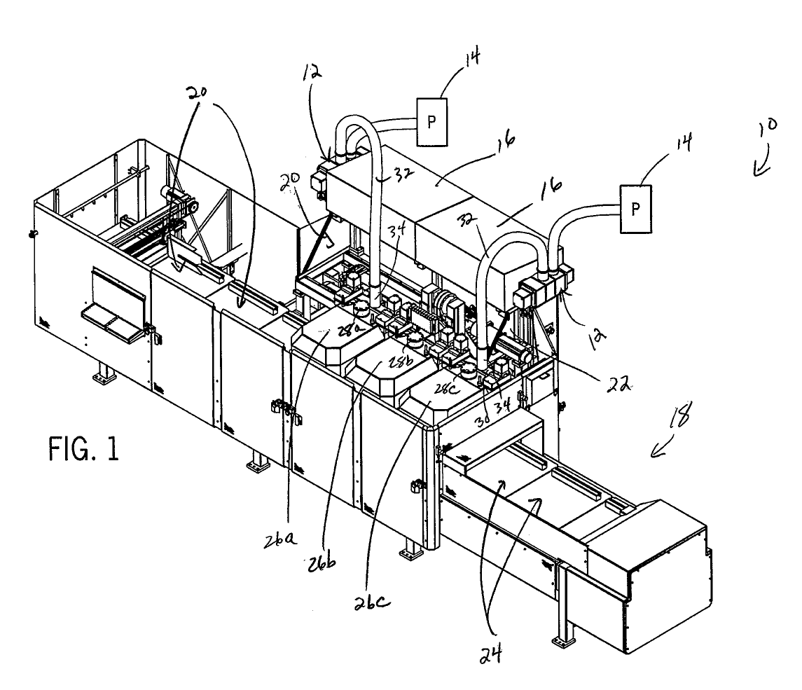

FIG. 1 illustrates a representative embodiment of a vacuum packaging system 10 incorporating a pair of control valve systems 12 to selectively connect a pair of vacuum pumps 14, a pair of evacuation vessels 16, and a volume to be evacuated to one another. In the illustrated example, the vacuum packaging system 10 is a linear motion vacuum packaging system and thus includes a conveyor 18 that advances items (not shown) to be vacuum packaged along the length of the vacuum packaging system 10 in a linear primary path of travel. The vacuum packing system 10 further includes an evacuation arrangement 20, which is mounted to a vertical support 22 that also holds the pair of evacuation vessels 16, with the control valve systems 12 mounted thereto, suspended above the evacuation arrangement 20. The control valve system 12 cooperates with conveyor 18 to evacuate and seal the items to be vacuum packaged as those items are conveyed by conveyer 18.

Conveyor 18 includes a series of platens 24, each of which is adapted to receive and support an article and receptacle (not shown). Generally, any article suitable for vacuum packaging, such as a perishable food products, may be vacuum packaged by the vacuum packaging system 10 and the receptacle may be any satisfactory open-ended receptacle sized to receive the article and suitable for vacuum packaging, as is known in the art. Conveyor 18 may be configured to advance incrementally at spaced intervals in an indexing fashion, or may be configured to provide continuous advancement of items supported by conveyor 18, either at a continuous rate of speed or at variable rates of speed. The platens 24 are advanced by conveyor 18 and cooperate with evacuation arrangement 20 to evacuate and seal an article within a receptacle.

The evacuation arrangement 20 includes a series of identical vacuum chambers or heads 26a-c, each of which is associated with a vacuum valve 28a-c that controls the supply of vacuum to the interior of the associated vacuum chambers 26a-c. More particularly, each vacuum chamber 26a-c is provided with negative pressure by a header 30 that is fluidly connected to pumps 14 by conduits 32, which may be hose, tubing, pipe, or the like. The header 30 includes fittings 34 that mate with conduits 32 to deliver negative pressure provided to the conduit 32 by pumps 14. When valves 28a-c are open, negative pressure is delivered from the header 30 to the vacuum chambers 26a-c. Header 30 acts as a combination vacuum manifold and support for vacuum heads 26a-c, and replaces the need for each vacuum chamber 26a-c to be directly connected to pumps 14.

The vacuum packaging system 10 and evacuation arrangement 20 include components not specifically described herein, but which are known in the art, such as a user interface module, various drive motors, drive belts, belt tensioners, guide rollers, and pulleys, as described in PCT Application PCT/US2005/015833, the disclosure of which is incorporated herein by reference.

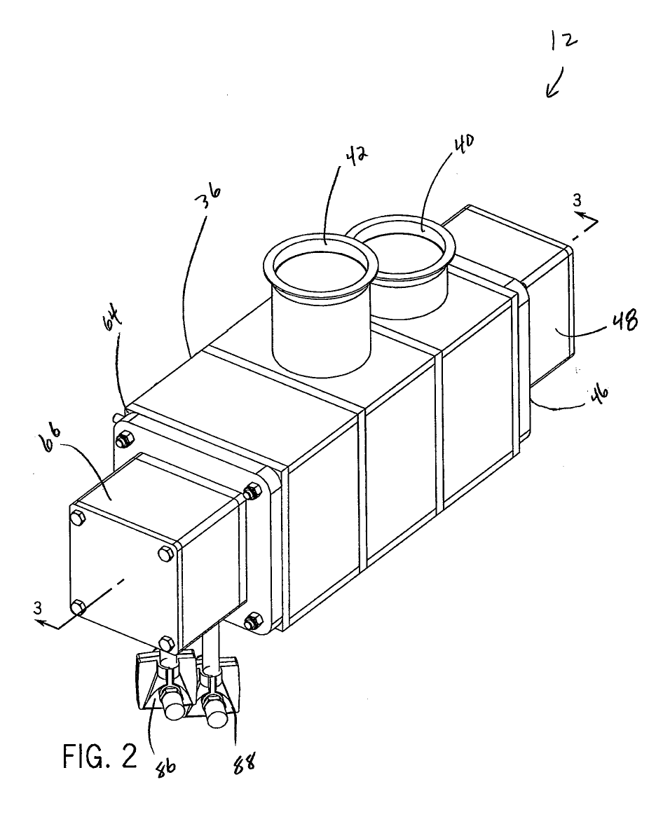

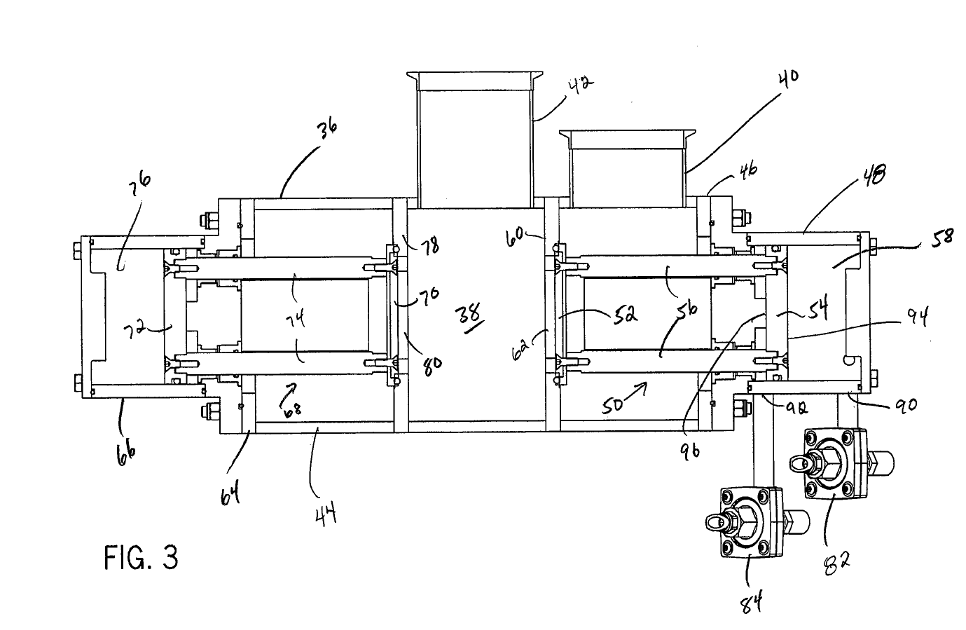

Referring now to FIGS. 2-3, a representative embodiment of a control valve system 12 for selectively connecting a vacuum chamber, e.g., 26a, 26b, or 26c, to either vacuum pump 14 or evacuation vessel 16 includes a central body 36 providing an internal chamber 38 that communicates with one of vacuum pumps 14 through a pipe, hose, or tube attached to a fitting 40. Similarly, the internal chamber 38 communicates with header 30 through a pipe, hose, or tube attached to fitting 42, which is shown as conduit 32 in FIG. 1. The internal chamber 38 further includes an outlet 44 that fluidly communicates with an inlet of an evacuation vessel 16. A valve body 48 is mounted in a sealed manner to one end 46 of the central body 36, and contains a valve 50 that is controlled to selectively establish fluid communication between the vacuum pump 14 and either evacuation vessel 16 or header 30. Valve 50, in one embodiment, is pneumatically controlled, and includes a valve plate 52 connected to a piston or armature 54 by a pair of transverse members 56. The valve body 48 provides a sealed volume 58 in which the armature 54 reciprocates.

The internal chamber 38 is partially defined by a sidewall 60 having an opening 62 that forms an internal fluid passage between the internal chamber 38 and the vacuum pump 14 when valve 50 is in an open or retracted position. When the valve 50 is in a closed position, as shown in FIG. 3, pressure maintained in the sealed volume 58 forces armature 54 inwardly thereby causing plate 52 to cover, in a sealed manner, opening 62. As a result, fluid communication between the internal chamber 38 and the vacuum pump 14 is prevented. When the armature 54 is forced outwardly, the plate 52 is drawn away from the opening 62 thereby establishing communication between the internal chamber 38 and the vacuum pump 14.

A valve body 66 is mounted in a sealed manner to an opposite end 64 of the central body 36, and contains a valve 68 that is controlled to selectively establish fluid communication between the evacuation vessel 16 and either pump 14 or header 30. Valve 68 is similar in construction to valve 50 described above. Specifically, valve 68, in one embodiment, is pneumatically controlled, and includes a valve plate 70 connected to a piston or armature 72 by a pair of transverse members 74. The valve body 66 provides a sealed volume 76 in which the armature 72 reciprocates.

The internal chamber 38 is also partially defined by sidewall 78, opposite sidewall 60, and similarly has an opening 80 that forms an internal fluid passage between the internal chamber 38 and the evacuation vessel 16 through outlet 44 when valve 68 is in an open or retracted position. In one embodiment, openings 62, 80 are generally aligned with one another.

In operation, when the valve 68 is at a closed position, as shown in FIG. 3, pressure maintained in the sealed volume 76 forces armature 72 inwardly thereby causing plate 70 to cover, in a sealed manner, opening 80. As a result, fluid communication between the internal chamber 38 and the evacuation vessel 16 is prevented. When the armature 72 is forced outwardly or retracted, the plate 70 is drawn away from the opening 80 thereby establishing communication between the internal chamber 38 and the evacuation vessel 16.

As described above, valve bodies 50, 68 each provide a sealed volume 58, 76, respectively, in which armatures 54, 72, respectively, are reciprocated to selectively control opening and closing of the valves. In one embodiment, the armatures 54, 72 are linearly reciprocated in their respective valve bodies pneumatically. In this regard, each valve body 48, 66 is fluidly connected to a pair of conduits 82, 84 and 86, 86, respectively, that deliver air to the respective volumes 58, 76 to cause liner motion of armatures 54, 72, respectively.

For example, referring to FIG. 3, valve body 48 includes a pair of openings 90, 92 coupled to conduits 82, 84, respectively. Conduit 82 provides air to the volume 58 through opening 90 that bear against rear surface 94 of armature 54. As air is delivered through opening 90, air is extracted, either forcibly using a pump or passively, from biasing a front surface 96 of the armature 54. Thus, the armature 54 travels inwardly until plate 52 engages sidewall 60 thereby closing opening 62. To retract the armature 54, air is removed from volume 58 through opening 90 and air is provided forward of the front surface 96 of the armature 54 through opening 92. Valve 68 is similarly controlled by air supplied and removed through conduits 86, 88.

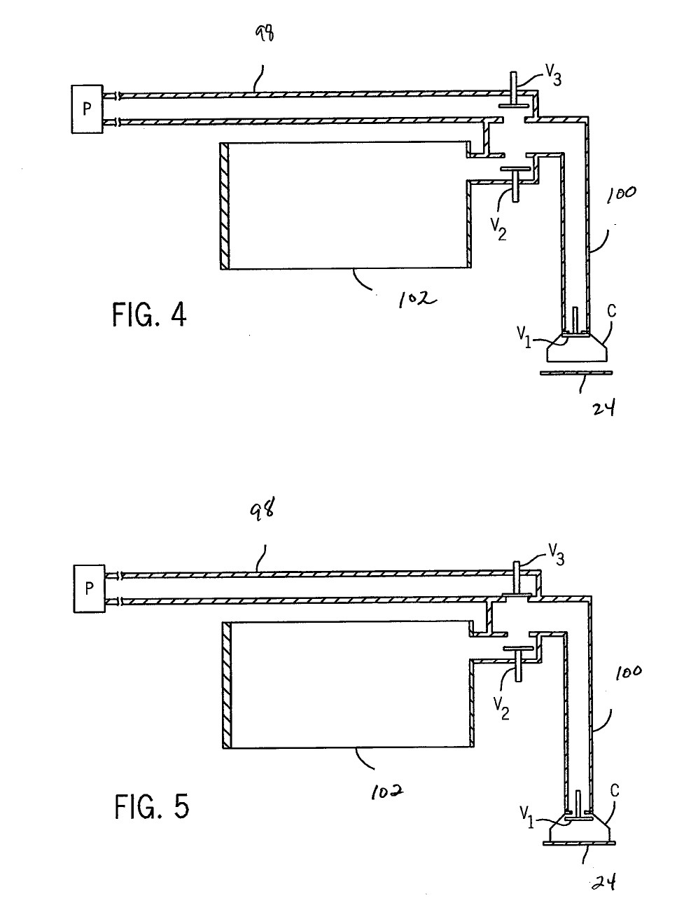

Operation of the control valve system to selectively establish communication between a vacuum pump, evacuation vessel, and vacuum chamber will be described with respect to FIGS. 4-7. With reference to FIG. 4, a vacuum pump P, such as pump 14, is interconnected with a conduit 98, which may be a pipe, tube, hose or any other satisfactory closed conveying member. A vacuum volume or chamber C, such as one of vacuum chambers 26a-c, is interconnected with a conduit 100, which likewise may be a pipe, tube, hose or any other satisfactory closed conveying member. Volume or chamber C may be a vacuum head which, in a manner as is known, is adapted to be brought into contact with an underlying platen 24 for evacuating a volume defined by the chamber C and platen 24, such as in a vacuum packaging application. It is understood, however, that volume or chamber C may be any closed volume to which negative air pressure is to be supplied, for evacuating the closed volume. A valve V1, such as valve 28a, is positioned between the interior of chamber C and the passage of conduit 100, for selectively establishing and cutting off communication between the interior of chamber C and the passage of conduit 100.

A closed, fixed-volume evacuation tank 102, which may be in the form of evacuation vessel 16, defines an internal volume that is adapted to be selectively exposed either to the internal passage of conduit 98, the internal passage of conduit 100, or both. Preferably, the volume of vessel 102 is at least equal to the volume to be evacuated, i.e. the volume of chamber C in combination with the volume defined by the conduit 100 between the outlet of vessel 102 and chamber C. A valve V2, such as valve 68, is configured to selectively open or close the outlet of vessel 102. A valve V3, such as valve 50, is configured to selectively open or close the internal passage of conduit 98.

Vessel 102, in combination with valves V1, V2 and V3, functions to deliver negative air pressure to the interior of chamber C much more efficiently, and in a shorter time period, than is possible in the prior art. Essentially, vessel 102 acts as a vacuum or negative air pressure volume or reservoir that is selectively exposed to the interior of chamber C, and then isolated from chamber C and exposed to pump P, to enable pump P to quickly and efficiently attain a desired level of negative air pressure within the interior of chamber C.

In an initial position, as shown in FIG. 4, valve V1 is closed and valves V2 and V3 are open. Vacuum pump P is operated so as to evacuate conduits 98, 100, as well as the interior of vessel 102. In the closed position, valve V1 prevents the interior of chamber C from being exposed to the negative air pressure in the passage of conduit 98, so that the interior of chamber C is at ambient air pressure.

FIG. 5 illustrates the positions of valves V1, V2 and V3 when negative air pressure is to be delivered to the interior of chamber C such as, for example, when chamber C is lowered onto platen 24 for evacuating a package supported on the platen 24. As shown in FIG. 5, valve V3 is closed and valves V1 and V2 are open. Immediately upon opening both valves V1 and V2, the negative pressure within the interior of vessel 102 is communicated through the vessel outlet to the passage of conduit 100, and through valve V1 to the interior of chamber C. While this action functions to raise the air pressure within the interior of vessel 102, it immediately and significantly lowers the air pressure within the interior of chamber C.

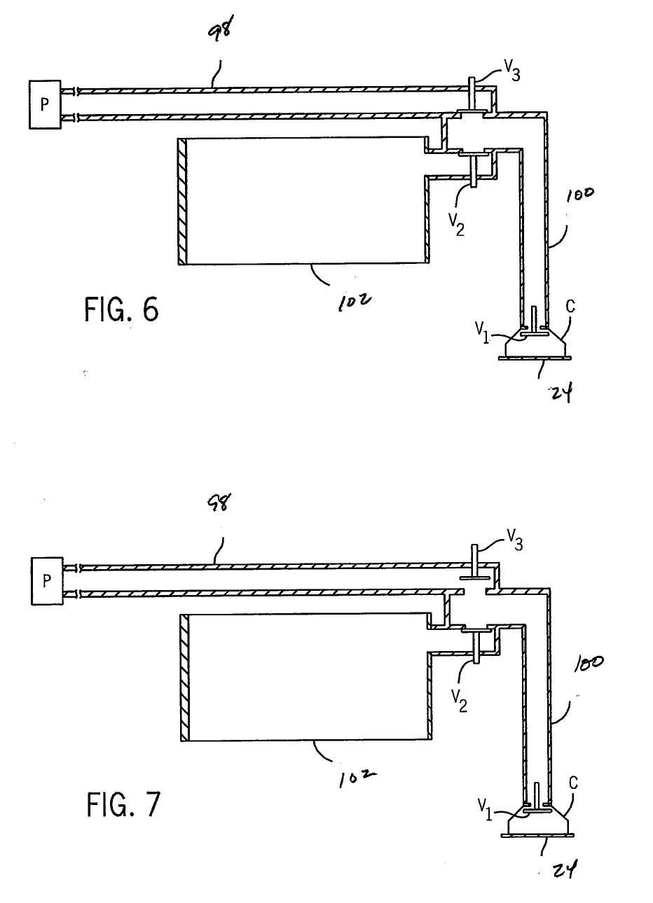

As shown in FIG. 6, valve V2 is then closed so as to isolate the interior volume of vessel 102 from the interior of conduit 100 and the interior of chamber C. Valve V1 remains open. The system then immediately progresses to open valve V3, as shown in FIG. 7, so that negative air pressure from conduit 98 and pump P is communicated through valve V3, the passage of conduit 100, and valve V1 to the interior of chamber C. Vacuum pump V thus begins its evacuation cycle with the interior of chamber C already at a significant negative air pressure due to exposure of the interior of chamber C to the negative air pressure within vessel 102 as shown in FIG. 5.

With this system and method, it is possible to use a similarly sized vacuum pump as is in the prior art while significantly reducing the amount of time that it takes to fully evacuate the interior of chamber C, since the interior of chamber C is already at a relatively low negative air pressure before pump P begins the evacuation cycle. It has been found that, in vacuum delivery systems, vacuum pumps do not operate efficiently in initially removing the dead air required to evacuate a volume, which often is contained within hoses, pipes, fittings and the like. Efficiency of a vacuum pump increases significantly as vacuum. pressure is lowered. With the efficiencies offered by the initial delivery of negative air pressure to the volume to be evacuated, by operation of selective exposure of the interior of chamber C to the negative air pressure in the interior of tank 102, the vacuum pump P is able to begin operation in the range of increased efficiency without having to move the dead air volume as in the prior art.

In addition, in the event the evacuation time is not critical, it is possible to use a smaller vacuum pump than in the prior art in order to achieve the required vacuum pressure level within the interior of the chamber C. Since chamber C is already exposed to a significant vacuum pressure even before operation of pump P commences, pump P is able to operate in its more efficient range so as to deliver the required level of vacuum pressure to the interior of chamber C. The ability to use a smaller vacuum pump than in the prior art is significant, since vacuum pumps are very expensive items and the cost of a vacuum pump increases with size and capacity. In addition, the present invention enables the vacuum pump to be at a remote location, or at least farther away, from the chamber C than is possible in the prior art. In the past, it has been desirable to position the vacuum pump as close as possible to the chamber, so as to reduce the length of the pipes or hoses and therefore the volume of air that must be moved in order to achieve the desired vacuum level.

The vacuum packaging system has been shown as having two pumps connected to a header at two ports and also having two evacuation vessels. It is understood that more than two pumps or a single pump may be used, or more than two evacuation vessels or a single evacuation vessel may be used.

The present invention has been described in terms of the preferred embodiment, and it is recognized that equivalents, alternatives, and modifications, aside from those expressly stated, are possible and within the scope of the impending claims.

1.-10. (canceled)

11. A method of supplying negative air pressure to a volume, comprising the steps of:
cutting off communication between the volume and both a vessel and a vacuum source;
establishing communication between the vessel and the vacuum source;
communicating negative pressure to the vessel from the vacuum source;
cutting off communication between the vessel and the vacuum source;
establishing communication between the vessel and the volume;
communicating negative pressure from the vessel to the volume;
cutting off communication between the vessel and the volume while maintaining the reduced pressure in the volume;
subsequently establishing communication between the vacuum source and the volume; and
communicating negative pressure to the volume from the vacuum source.

12. The method of claim 11 wherein the vacuum source is a vacuum pump.

13. The method of claim 11 wherein communication to the volume is controlled by a first valve.

14. The method of claim 13 wherein communication to the vessel is controlled by a second valve.

15. The method of claim 14 wherein communication to the vacuum source is controlled by a third valve.

16. A method of supplying negative air pressure to a volume, comprising the steps of:
closing a first valve to cut off communication between the volume and both a vessel and a vacuum source;
establishing communication between the vessel and the vacuum source via a second valve and a third valve;
communicating negative pressure to the vessel from the vacuum source;
closing the third valve to cut off communication between the vessel and the vacuum source;
establishing communication between the vessel and the volume via the first and second valves;
communicating negative pressure from the vessel to the volume;
closing the second valve to cut off communication between the vessel and the volume;
subsequently establishing communication between the vacuum source and the volume via the first and third valves; and
communicating negative pressure to the volume from the vacuum source.

17. The method of claim 16 wherein the vacuum source is a vacuum pump.

18. A method of supplying negative air pressure from a vacuum pump to evacuate a volume, comprising the steps of:
closing a first valve to cut off communication between the volume and a first end of a first conduit;
opening a second valve to establish communication between a vessel and a second end of the first conduit;
opening a third valve to establish communication between a first end of a second conduit and the second end of the first conduit;
communicating negative pressure from the vacuum pump to the vessel, wherein the vacuum pump is connected to a second end of the second conduit;
closing the third valve to cut off communication between the first end of the second conduit and the second end of the first conduit;
opening the first valve to establish communication between the volume and the first end of the first conduit;
communicating negative pressure from the vessel to the volume;
closing the second valve to cut off communication between the vessel and the second end of the first conduit;
opening the third valve to establish communication between the first end of the second conduit and the second end of the first conduit; and
communicating negative air pressure to the volume from the vacuum pump.

19. The method of claim 18 wherein the volume of the vessel is at least as large as the combined volume of the first conduit and the volume to be evacuated.
